(19) United States
(12) Patent Application Publication
(10) Pub. No.: US 2003/0163590 A1
(43) Pub. Date: Aug. 28, 2003

(54) Directly transferring transmit data in an embedded adapter

(76) Inventor: Lei Cheng, Austin, TX (US)

Correspondence Address: Timothy N. Trop, TROP, PRUNER & HU, P.C., 8554 KATY FWY, STE 100, HOUSTON, TX, 77024-1841, US

(21) Appl. No.: 10/082,893

(22) Filed: Feb. 26, 2002

(51) Int. Cl. G06F 15/16

(52) U.S. Cl. 709/250

(57) ABSTRACT

In accordance with one embodiment of the present invention, an Ethernet device may receive data directly from a host memory without intervening storage in an embedded memory. This may improve system performance. The embedded memory may include a transmit descriptor ring and a transmit data buffers with pointers that point from the transmit descriptor ring to the locations of the data. If the data to be transferred is of a larger size than the size of an Ethernet packet, data can be broken up and spread into more than one packet for transmission.

### BACKGROUND

This invention relates generally to embedded adapters for use in processor-based systems.

A Small Computer System Interface over Transmission Control Protocol/Internet Protocol(TCP/IP) protocol (iSCSI) adapter may include an Ethernet device coupled to a secondary bus, an embedded memory coupled to an embedded bus bridge and an embedded processor or controller. The embedded processor has a transmit descriptor ring that resides in the embedded memory. The ring has a number of transmit descriptors. In addition, there are some transmit data buffers in the embedded memory that are pointed to by the descriptor entries in the ring.

The Ethernet device uses the transmit descriptor ring and the transmit data buffers to transfer Ethernet packets from the embedded memory to the Ethernet device. Some of the Ethernet packets may have originated in the protocol stack on the adapter. Other Ethernet packets may get data from the host memory.

Conventionally, data is copied to the embedded memory from the host. Then, the Ethernet packet is formed and the packet is put in the transmit buffer in the embedded memory. This operation involves making one copy of data from the host to the embedded memory. This copy decreases the performance of the adapter.

Thus, there is a need for a way to avoid the copying of host data to the embedded memory when transferring data to an Ethernet device.

### BRIEF DESCRIPTION OF THE DRAWINGS

FIG. 1 is a schematic depiction of one embodiment of the present invention;

FIG. 2 shows the transmit descriptor ring, transmit data buffers and the resulting Ethernet packets in accordance with one embodiment of the present invention;

FIG. 3 is a schematic depiction of a data transfer in accordance with one embodiment of the present invention;

FIG. 4 is a schematic depiction of data transfer in accordance with another embodiment of the present invention;

FIG. 5 is a flow chart for one embodiment of the present invention; and

FIG. 6 is a flow chart showing how data from an Ethernet device may be routed in accordance with one embodiment of the present invention.

### DETAILED DESCRIPTION

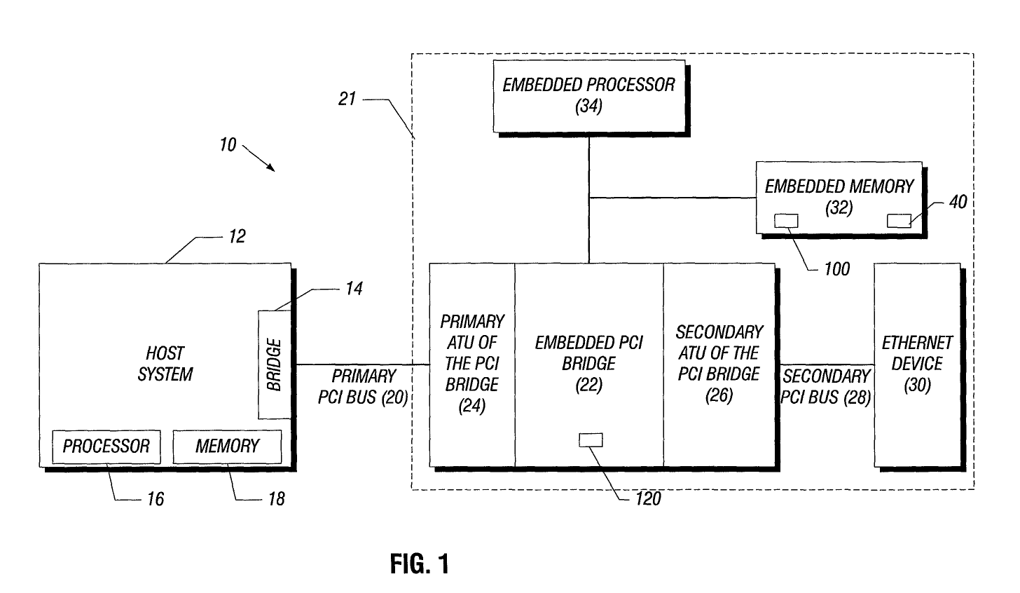

Referring to FIG. 1, a processor-based system 10 may be a desktop computer, a laptop computer, a server or any of a variety of other computer or processor-based devices. The system 10 includes a host system 12 with a bridge 14 that enables the host system 12 to communicate with a primary bus 20, such as a Peripheral Component Interconnect (PCI) bus, in accordance with one embodiment of the present invention. The host system 12 may include a processor 16 and a memory 18 coupled to a bridge 14 pursuant to any of a variety of available architectures.

The primary bus 20 is coupled to an embedded bridge 22, in accordance with one embodiment of the present invention. The bridge 22 includes a primary address translation unit (ATU) 24 and a secondary address translation unit (ATU) 26. The secondary address translation unit 26 is coupled to a secondary bus 28 which in turn couples an Ethernet device 30. The secondary bus 28 may be a PCI bus in one embodiment.

In one embodiment, the Ethernet device 30 is part of an iSCSI adapter 21 that also includes the embedded memory 32 and an embedded processor 34. The processor 34 and memory 32 couple to the bridge 22, in accordance with one embodiment of the present invention.

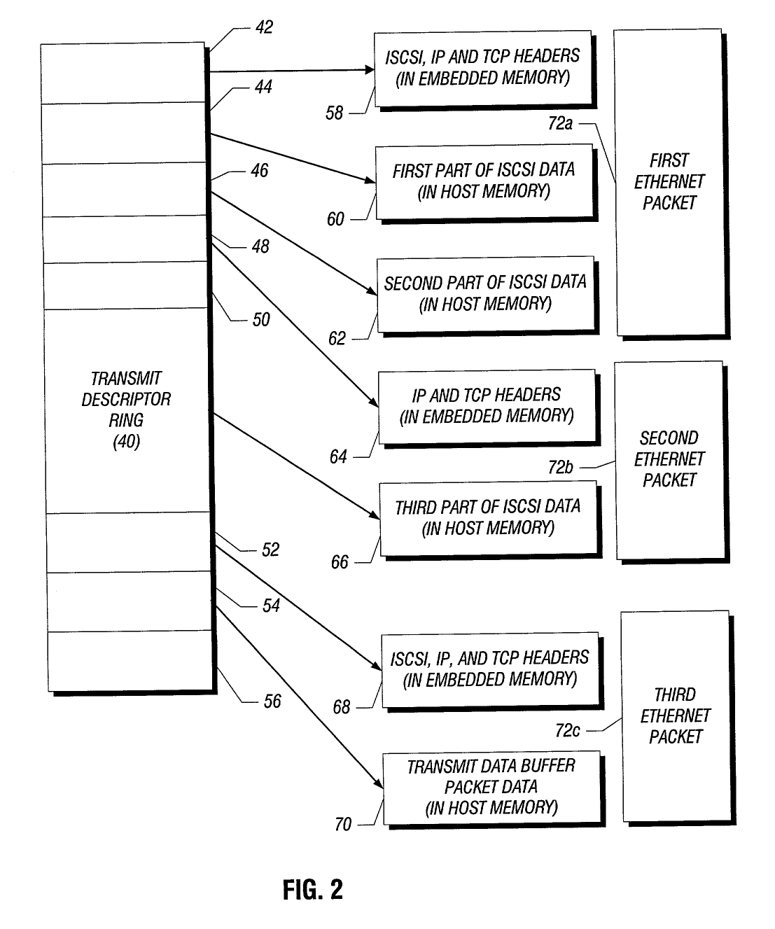

The embedded memory 32 may store a transmit descriptor ring 40. Referring to FIG. 2, the transmit descriptor ring 40 may include a plurality of transmit descriptors 42 through 56. Each transmit descriptor 42 through 56 has a pointer that points to a particular transmit data buffer 58 through 70, stored in the embedded memory 32 or host memory 18. The Ethernet device 30 uses the transmit descriptor ring 40 and the transmit data buffers 58 through 70 to transmit Ethernet packets from the embedded memory 32 or from the host memory 18 to the Ethernet device 30.

The iSCSI protocol data units (PDUs) may be stored in the host memory 18. Protocol headers such as Ethernet, Transmission Control Protocol/Internet Protocol (TCP/IP), and iSCSI headers may be formed in the embedded memory 32. The iSCSI protocol data units may reside in several physical memory blocks that may not be contiguous in some embodiments.

The descriptors 42 through 56 separately point to the headers and data. For example, as shown in FIG. 2, the transmit descriptor 42 points to embedded memory transmit data buffer 58 where iSCSI, IP and TCP headers may be resident, in one embodiment. Similarly, the transmit descriptor 44 points to host memory transmit data buffer 60 where a first part of the iSCSI data is resident.

The Ethernet device 30 may perform cyclic redundancy checks (CRC) for Ethernet and TCP/IP checksums. Firmware may compute the ISCSI header for the CRC. As a result, the iSCSI data stays in the host memory 18 until it is transferred to the Ethernet device 30.

A single iSCSI protocol data unit (PDU) may be larger than the Ethernet maximum transfer unit (MTU) size. In such case, only the first Ethernet packet 72a has TCP/IP and iSCSI headers. One or more following Ethernet packets, such as the packet 72b have only IP and TCP headers but no ISCSI header. Thus, a given ISCSI protocol data unit may be divided among two Ethernet packets 72a and 72b and then the next iSCSI data protocol data unit may be placed in a third Ethernet packet 72c as one example.

For example, iSCSI, IP and TCP headers from the embedded memory data buffer 58 and a first part of the iSCSI data from the host memory transmit data buffer 60 may be loaded into the first Ethernet packet 72a together with the data from the host memory transmit data buffer 62 that includes the second part of the iSCSI data. The second Ethernet packet 72b includes the IP and TCP headers from the embedded memory data buffer 64 and the third part of the iSCSI data from the host memory transmit data buffer 66.

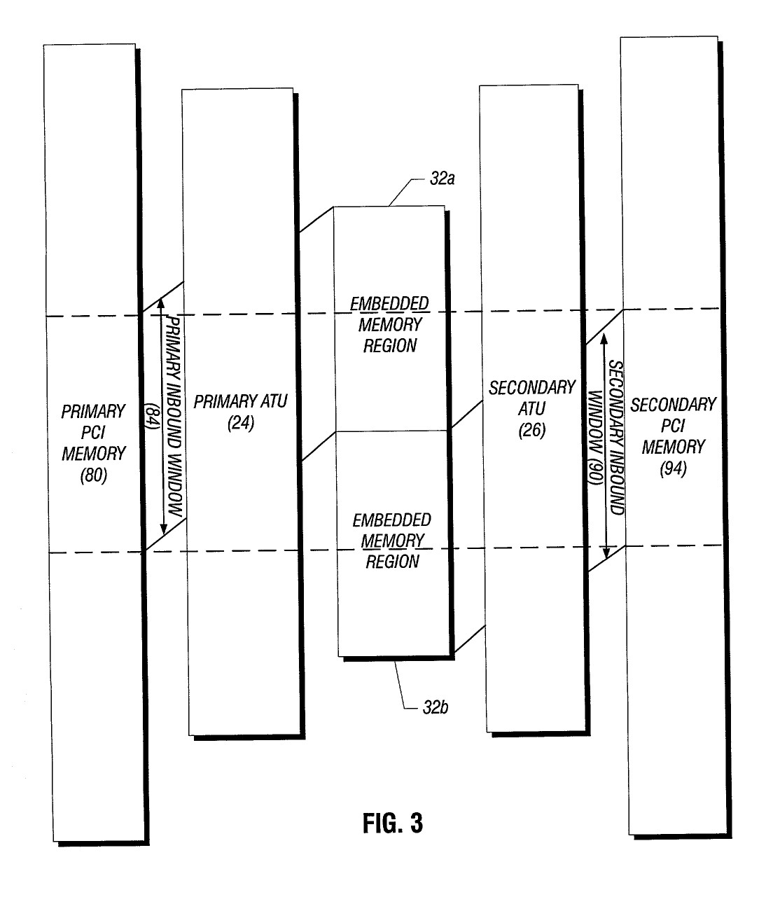

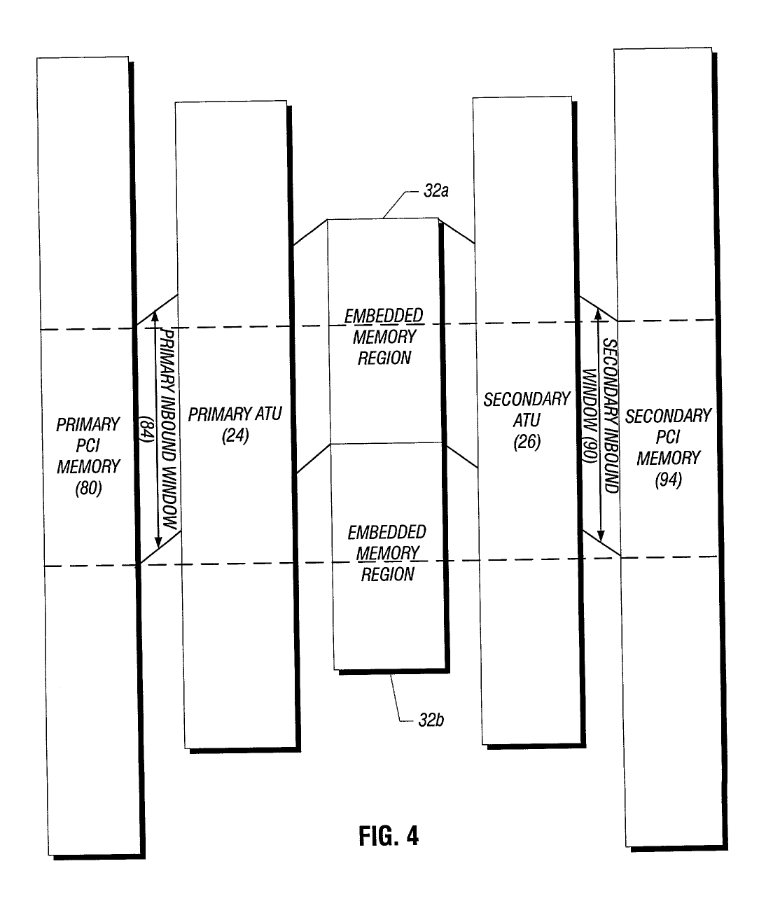

Referring to FIG. 3, the primary bus memory 80 may access a primary inbound window 84 in a primary address translation unit 24 in one embodiment. Data may be transferred through the primary inbound window 84 to the embedded memory region 32a. Alternatively, data may be transferred from the secondary bus memory 94 via a secondary inbound window 90 through the secondary address translation unit 26, for example, using the embedded memory region 32b, as one example. As another example, shown in FIG. 4, transfers associated with the secondary bus memory 94 and the primary bus memory 80, using one of the primary inbound window 84 and the secondary inbound window 90, may end up in the same memory region 32a.

The secondary inbound window 90 is set up so that it has the same address and limit as the primary inbound window 84. This is desirable because the entire host/primary bus memory region is advantageously accessible from the Ethernet device 30 on the secondary bus 28. If the secondary inbound window 90 is larger than the primary inbound window 84, a part of the host system 12 is not reachable by a device, such as the Ethernet device 30, on the secondary bus 28.

The embedded memory region 32a or 32b may correspond to the primary inbound window 84. The embedded memory region 32a may correspond to the primary inbound window region 84 and may be set as cacheable or cacheable memory as shown in FIGS. 3 and 4. The embedded memory region 32a (FIG. 4) or 32b (FIG. 3) corresponding to the secondary inbound window 90 can also be set up as cacheable or non-cacheable memory. Moreover, the embedded region 32a or 32b corresponding to either the primary inbound window 84 or the secondary inbound window 90 can be set up as the same or different regions inside the embedded memory 32.

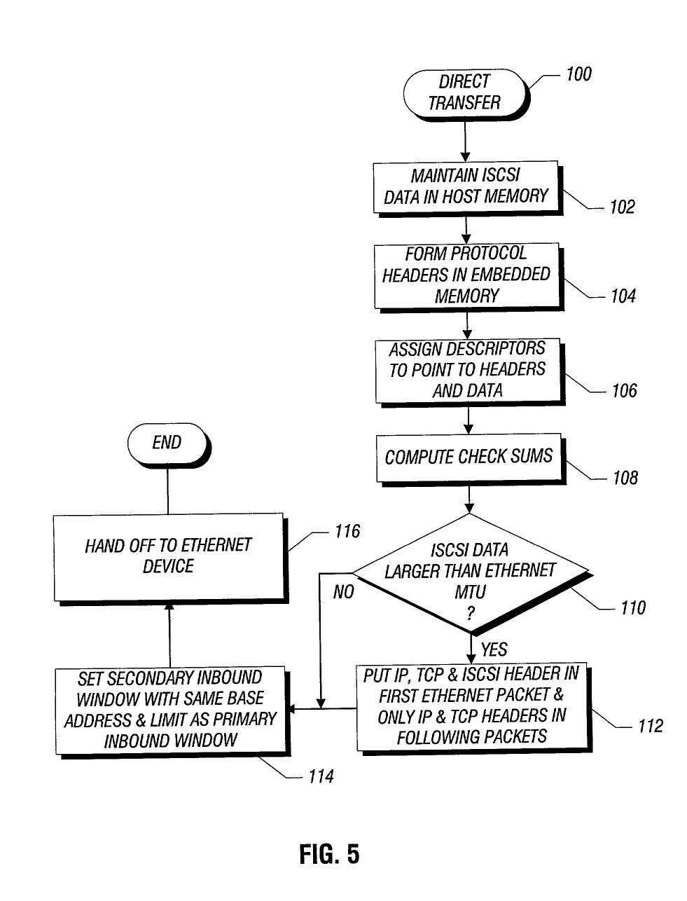

Referring to FIG. 5, the direct transfer protocol 100 may be stored as code in the embedded memory 32 in one embodiment of the present invention. The protocol 100 sets up transfers from the host memory 18 to the Ethernet device 30 without making a copy to the embedded memory 32. The protocol 100 maintains the iSCSI data in the host memory 18 as indicated in block 102. Protocol headers are formed in the embedded memory 32 as indicated in block 104. Descriptors are assigned to point to headers and data as indicated in block 106 and as illustrated in FIG. 2. The checksums may then be computed as described previously and as indicated in block 108.

Referring next to diamond 110, a check determines whether the iSCSI protocol data unit is larger than the Ethernet maximum transmit unit size. If so, the IP, TCP and iSCSI headers are put in a first Ethernet packet and only IP and TCP headers may be placed in ensuing packets as indicated in block 112 and as further illustrated in FIG. 2.

The secondary inbound window 90 is set with the same base address and limit as the primary inbound window 84, as indicated in block 114. The system 10 is then set up for direct transfer of iSCSI data from the host memory 18 to the Ethernet device 30 without intervening storage in the embedded memory 32.

The direct iSCSI data transfer increases the iSCSI transmit performance since it eliminates the copying of the iSCSI data from the host memory 18 to the embedded memory 32. This avoids performance losses due to poor embedded memory performance. This approach may be useful, in particular, in connection with storage area networks.

The bridge 22 is set up for direct transfer of host data. The secondary bus address space may be divided into two areas. One of those areas is inside the secondary inbound window 90 and the other is outside the secondary inbound window 90. All secondary bus address accesses inside the secondary inbound window 90 are translated by the ATU 26 and forwarded to the embedded memory 32. All secondary bus address accesses outside the secondary inbound window 90 are forwarded to the host memory 18 without any translation. Thus, data coming off the secondary bus 28 either goes to the embedded memory 32 or the host memory 18 depending on where its address lies.

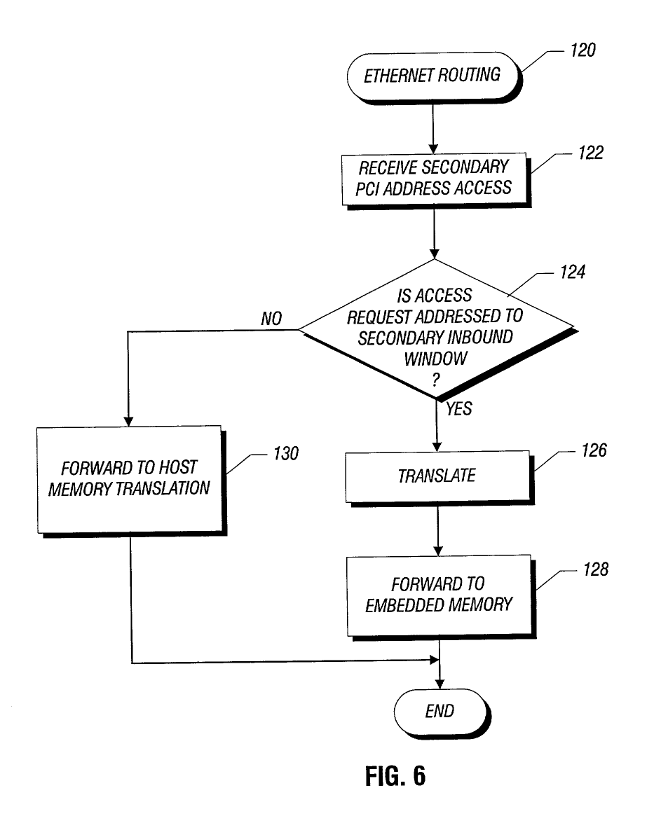

Referring to FIG. 6, data coming off the secondary bus 28 from the Ethernet device 30 may be processed in the embedded bridge 22 by the code 120 in accordance with one embodiment of the present invention. Initially, the bridge 22 receives a secondary bus address access as indicated in block 122. A check at diamond 124 determines whether the access request is addressed to the secondary inbound window 90. If so, the access request is translated as indicated in block 126 and forwarded to the embedded memory 32 as indicated in block 128.

If the access request is not addressed to the secondary inbound window 90, as determined in diamond 124, then the request is forwarded to the host memory 18 without translation as indicated in block 130.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
transferring data from a host memory to an Ethernet device; and
processing the data without sending the data from the host memory to an embedded memory associated with an adapter that includes the Ethernet device.

2. The method of claim 1 including forming protocol headers in the embedded memory.

3. The method of claim 1 including assigning descriptors to point to headers and data.

4. The method of claim 3 including assigning descriptors to point to headers and data in said embedded memory and host memory.

5. The method of claim 1 including computing checksums in firmware and in the Ethernet device.

6. The method of claim 1 including determining whether data in said host memory is larger than an Ethernet maximum transmit unit.

7. The method of claim 6 wherein if said data is larger than an Ethernet maximum transmit unit, placing said data in at least two different Ethernet packets.

8. The method of claim 7 including placing more headers in one Ethernet packet than in another Ethernet packet.

9. The method of claim 1 including forming a primary inbound window to receive data from a host and forming a secondary inbound window to receive data from said Ethernet device, said secondary inbound window having the same base address and limit as the primary inbound window.

10. The method of claim 1 including detecting the address of an access request from an Ethernet device and routing said request to the host memory or embedded memory based on the address.

11. An article comprising a medium storing instructions that enable a processor-based system to:
transfer data from a host memory to an Ethernet device; and
process the data without sending the data from the host memory to an embedded memory associated with an adapter that includes the Ethernet device.

12. The article of claim 11 comprising a medium storing instructions that enable a processor-based system to form protocol headers in the embedded memory.

13. The article of claim 11 comprising a medium storing instructions that enable a processor-based system to assign descriptors to point to headers and data.

14. The article of claim 13 comprising a medium storing instructions that enable a processor-based system to assign descriptors to point to headers and data in both said embedded memory and host memory.

15. The article of claim 11 comprising a medium storing instructions that enable a processor-based system to compute checksums in firmware and in the Ethernet device.

16. The article of claim 11 comprising a medium storing instructions that enable a processor-based system to determine whether data in said host memory is larger than an Ethernet maximum transmit unit.

17. The article of claim 16 comprising a medium storing instructions that enable a processor-based system to, place said data in at least two different Ethernet packets if said data is larger than an Ethernet maximum transmit unit.

18. The article of claim 17 comprising a medium storing instructions that enable a processor-based system to place more headers in an Ethernet packet than in another Ethernet packet.

19. The article of claim 11 comprising a medium storing instructions that enable a processor-based system to form a primary inbound window to receive data from a host and form a secondary inbound window to receive data from said Ethernet device, said secondary inbound window having the same base address and limit as the primary inbound window.

20. The article of claim 11 comprising a medium storing instructions that enable a processor-based system to detect the address of an access request from an Ethernet device and route said request to the host memory or embedded memory based on the address.

21. An adapter comprising:
a processor to communicate with a host system including a host memory;
an Ethernet device coupled to said processor; and
an embedded memory coupled to the processor to enable data to be transferred directly from the host memory to the Ethernet device without being copied to said embedded memory.

22. The adapter of claim 21 including descriptors that point to headers and data in said host memory and said embedded memory.

23. The adapter of claim 21 wherein said processor determines whether data in the host memory is larger than an Ethernet maximum transmit circuit.

24. The adapter of claim 23 wherein said processor places said data in at least two different Ethernet packets when said data is larger than said maximum transmit circuit.

25. The adapter of claim 24 wherein said processor places more headers in one Ethernet packet than in another Ethernet packet.

26. A system comprising:
a host processor;
a host memory coupled to said host processor;
a bridge coupled to said host processor; and
an adapter coupled to said bridge, said adapter including a processor, an embedded memory and an Ethernet device, said adapter to transfer data directly from said host memory to said Ethernet device without copying the data to the embedded memory.

27. The system of claim 26 wherein said bridge detects the address of an access request from said Ethernet device and routes said request to the host memory or embedded memory based on said address.

28. The system of claim 26 wherein said bridge includes a primary and secondary address translation unit, a primary memory coupled to the primary address translation unit and a secondary memory coupled to the secondary address translation unit.

29. The system of claim 28 wherein the primary inbound window of said primary memory is of the same size as the secondary inbound window of said secondary memory.

30. The system of claim 29 wherein said embedded memory is cacheable.
